(19) United States
(12) Patent Application Publication
(10) Pub. No.: US 2020/0334449 A1
(43) Pub. Date: Oct. 22, 2020

(54) OBJECT DETECTION BASED ON NEURAL NETWORK

(71) Applicant: Microsoft Technology Licensing, LLC, Redmond, WA (US)

(72) Inventors: Dong Chen, Beijing (CN); Fang Wen, Beijing (CN); Gang Hua, Sammamish, WA (US); Xiang Ming, Redmond, WA (US)

(21) Appl. No.: 16/959,100

(22) PCT Filed: Jan. 8, 2019
(86) PCT No.: PCT/US2019/012798

§ 371 Date: Jun. 29, 2020

(30) Foreign Application Priority Data
Jan. 30, 2018 (CN) 201810091820.4

(51) Int. Cl. G06K 9/00; G06K 9/62; G06N 3/08

(52) U.S. Cl. CPC G06K 9/00248; G06K 9/6292; G06K 9/00362; G06N 3/08; G06K 9/627

(57) ABSTRACT

Embodiments of the subject matter described herein relate to object detection based on neural network. In some implementations, a candidate region in an image, a first score and a plurality of positions associated with the candidate region are determined from a feature map of the image, and the first score indicates a probability that the candidate region corresponds to a particular portion of an object. A plurality of second scores are determined from the feature map and indicate probabilities that the plurality of positions correspond to a plurality of parts of the object, respectively. A final score of the candidate region is determined based on the first score and the plurality of second scores, to identify the particular portion of the object in the image.

### BACKGROUND

Detecting humans from images or videos is the foundation of many applications, such as identity recognition, and action recognition, and so on. Currently, a solution is a face-based detection. However, in some situations, it is difficult to detect the human face. For example, the situations include low resolution, occlusion, and large head pose variations. Another solution is to detect humans by detecting the human bodies. However, large pose variations of the body articulation and occlusions have an adverse effect on the body detection.

Therefore, there arises a need of an improved solution of object detection.

### SUMMARY

In accordance with implementations of the subject matter described herein, there is provided a head detection solution based on a neural network. In the solution, for a given image, it is desired to identify one or more objects or particular portions thereof in the image. Specifically, a candidate region, a first score, and a plurality of positions associated with the candidate region are determined from a feature map of the image, and the first score indicates a probability that the candidate region corresponds to a particular portion of an object. A plurality of second scores are determined from the feature map, the plurality of second scores indicate probabilities that the plurality of positions correspond to a plurality of parts of the object, respectively. A final score of the candidate region is determined based on the first score and the plurality of second scores, to identify the particular portion of the object in the image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram illustrating a computing device where implementations of the subject matter described herein can be implemented;

FIG. 2 illustrates an architecture of a neural network in accordance with an implementation of the subject matter described herein;

FIG. 3 is a diagram illustrating an object in accordance with an implementation of the subject matter described herein;

FIG. 4 is a diagram illustrating two objects having different scales in accordance with another implementation of the subject matter described herein;

FIG. 5 is a flowchart illustrating a method of object detection in accordance with an implementation of the subject matter described herein; and

FIG. 6 is a flowchart illustrating a method of training a neural network for object detection in accordance with an implementation of the subject matter described herein.

Throughout the drawings, the same or similar reference symbols refer to the same or similar elements.

### DETAILED DESCRIPTION OF EMBODIMENTS

The subject matter described herein will now be discussed with reference to several example implementations. It is to be understood these implementations are discussed only for the purpose of enabling those skilled persons in the art to better understand and thus implement the subject matter described herein, rather than suggesting any limitations on the scope of the subject matter.

As used herein, the term “includes” and its variants are to be read as open terms that mean “includes, but is not limited to.” The term “based on” is to be read as “based at least in part on.” The term “one implementation” and “an implementation” are to be read as “at least one implementation.” The term “another implementation” is to be read as “at least one other implementation.” The terms “first,” “second,” and the like may refer to different or same objects. Other definitions, explicit and implicit, may be included below.

### Example Environment

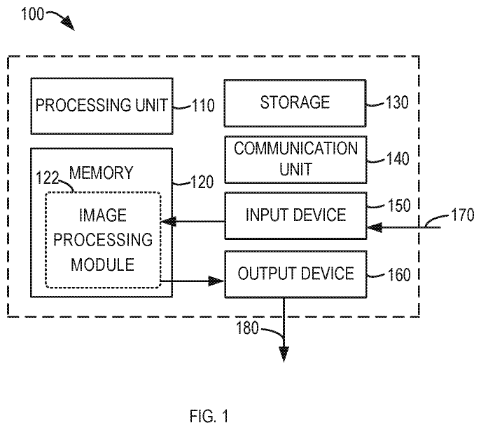

Basic principles and several example implementations of the subject matter described herein will be explained below with reference to the drawings. FIG. 1 is a block diagram illustrating a computing device 100 in which implementations of the subject matter described herein can be implemented. It is to be understood that the computing device 100 as shown in FIG. 1 is only exemplary and shall not constitute any limitations to the functions and scopes of the implementations described herein. As shown in FIG. 1, the computing device 100 includes a computing device 100 in the form of a general purpose computing device. Components of the computing device 100 may include, but not limited to, one or more processors or processing units 110, a memory 120, storage 130, one or more communication units 140, one or more input devices 150, and one or more output devices 160.

In some implementations, the computing device 100 can be implemented as various user terminals or service terminals with computing power. The service terminals can be servers, large-scale computing devices and the like provided by a variety of service providers. The user terminal, for example, is a mobile terminal, a stationary terminal, or a portable terminal of any types, including a mobile phone, a station, a unit, a device, a multimedia computer, a multimedia tablet, an Internet node, a communicator, a desktop computer, a laptop computer, a notebook computer, a netbook computer, a tablet computer, a Personal Communication System (PCS) device, a personal navigation device, a Personal Digital Assistant (PDA), an audio/video player, a digital camera/video, a positioning device, a television receiver, a radio broadcast receiver, an electronic book device, a gaming device, or any other combinations thereof including accessories and peripherals of these devices or any other combinations thereof. It may also be contemplated that the computing device 100 can support any types of user-specific interfaces (such as “wearable” circuit and the like).

The processing unit 110 can be a physical or virtual processor and can perform various processing based on the programs stored in the memory 120. In a multi-processor system, a plurality of processing units executes computer-executable instructions in parallel to enhance parallel processing capability of the computing device 100. The processing unit 110 also can be known as a central processing unit (CPU), a microprocessor, a controller, and a microcontroller.

The computing device 100 usually includes a plurality of computer storage media. Such media can be any available media accessible by the computing device 100, including but not limited to volatile and non-volatile media, removable and non-removable media. The memory 120 can be a volatile memory (e.g., register, cache, Random Access Memory (RAM)), a non-volatile memory (such as, Read-Only Memory (ROM), Electrically Erasable Programmable Read-Only Memory (EEPROM), flash), or any combinations thereof. The memory 120 can include an image processing module 122 configured to perform functions of various implementations described herein. The image processing module 122 can be accessed and operated by the processing unit 110 to perform corresponding functions.

The storage 130 may be removable or non-removable medium, and may include machine executable medium, which can be used for storing information and/or data and can be accessed within the computing device 100. The computing device 100 may further include a further removable/non-removable, volatile/non-volatile storage medium. Although not shown in FIG. 1, a disk drive may be provided for reading or writing from a removable and non-volatile disk and an optical disk drive may be provided for reading or writing from a removable and non-volatile optical disk. In such cases, each drive can be connected via one or more data medium interfaces to the bus (not shown).

The communication unit 140 carries out communication with another computing device through communication media. Additionally, functions of components of the computing device 100 can be implemented by a single computing cluster or a plurality of computing machines and these computing machines can communicate through communication connections. Therefore, the computing device 100 can be operated in a networked environment using a logical connection to one or more other servers, a Personal Computer (PC), or a further general network node.

The input device 150 can be one or more various input devices, such as a mouse, a keyboard, a trackball, a voice-input device, and/or the like. The output device 160 can be one or more output devices, for example, a display, a loudspeaker, and/or printer. The computing device 100 also can communicate through the communication unit 140 with one or more external devices (not shown) as required, where the external device, for example, a storage device, a display device, communicates with one or more devices that enable the users to interact with the computing device 100, or with any devices (such as network card, modem and the like) that enable the computing device 100 to communicate with one or more other computing devices. Such communication can be executed via Input/Output (I/O) interface (not shown).

The computing device 100 can be used to perform head detection in an image or video in accordance with implementations of the subject matter described herein. Since the video can be regarded as a sequential series of images, the image and the video can be used interchangeably in the context without causing any confusion. Therefore, the computing device 100 sometimes is referred to as an “image processing device” hereinafter. When head detection is performed, the computing device 100 can receive an image 170 through the input device 150. The computing device 100 can recognize one or more heads of object(s) in the image 170, and define a boundary or boundaries of one or more heads. The computing device 100 can output through the output device 160 the determined head(s) and/or boundary (boundaries) thereof as an output 180 of the computing device 100.

As described above, there are various types of problems in current facial detection and body detection, in particular problems of occlusion and poses. Implementations of the subject matter as described herein provide an object detection solution based on parts detection. For example, in the detection with the human as the object, since a head and shoulders can be approximated as rigid objects, the head and positions of the shoulders can be taken into account, and detection on the human can be performed by combining responses of these positions and the response of the head. It would be appreciated that the detection solution is not limited to human detection, but is applicable to other objects, such as an animal and the like. In addition, it would be appreciated that implementations of the subject matter as described herein can also be applied to detection for other substantially rigid parts of the object.

### System Architecture

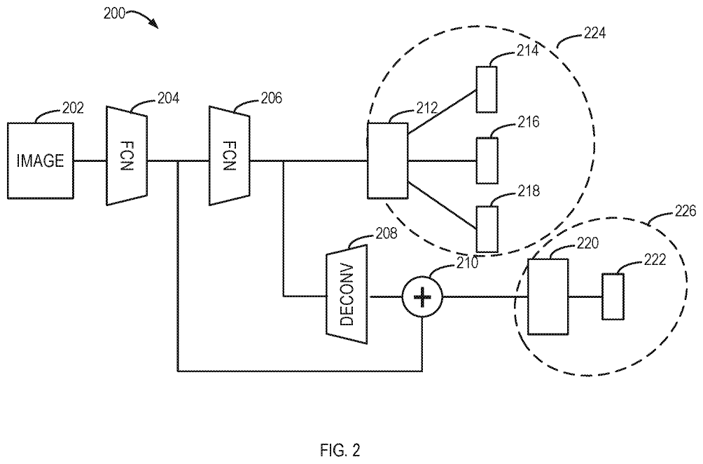

FIG. 2 is a schematic diagram illustrating a neural network 200 in accordance with implementations of the subject matter as described herein. As shown in FIG. 2, an image 202 is provided to a Fully Convolutional Neural Network (FCN) 204, which may for example be GoogLeNet. It would be appreciated that the FCN 204 can also be implemented by any other appropriate neural network currently known or to be developed in the future, for example a Residual Convolutional Neural Network (ResNet). The FCN 204 extracts a first feature map from the image 202, and for example, a resolution of the first feature map may be ¼ of the resolution of the image 202. The FCN 204 provides the first feature map to a FCN 206. Like the FCN 204, the FCN 206 can also be implemented by any other appropriate neural network currently known or to be developed in the future, for example a Convolutional Neural Network (CNN). The FCN 206 extracts a second feature map from the first feature map, and for example, a resolution of the second feature map may be ½ of the resolution of the first feature map, i.e., ⅛ of the image 202. The FCN 206 provides the second feature map to a subsequent Region Proposal Network (RPN). It would be appreciated that, although the neural network 200 in FIG. 2 includes the FCN 204 and the FCN 206, those skilled in the art may use more or fewer FCNs or other types of neural networks (for example, ResNet) to generate feature maps.

As shown in FIG. 2, the FCN 206 may be connected to a first Regional Proposal Network (RPN) 224, i.e., the second feature map output by the FCN 206 may be provided to the RPN 224. In FIG. 2, the RPN 224 may include an intermediate layer 212, a classification layer 214, and regression layers 216 and 218. The intermediate layer 212 may extract features from the second feature map to output a third feature map. For example, the intermediate layer 212 may be a convolution layer with a convolution kernel size of 3×3, and the classification layer 214 and the regression layers 216 and 218 may be a convolutional layer with a convolution kernel size of 1×1, respectively. However, it would be appreciated that one or more of the intermediate layer 212, the classification layer 214, and the regression layers 216 and 218 may include more or fewer convolution layers, or any other appropriate types of neural network layers.

As shown in FIG. 2, the RPN 224 includes three outputs, in which the classification 214 generates a score for a probability for a reference box (which is also referred to as a reference region or anchor) to be an object. The regression layer 216 regresses a bounding box and thus adjusts the reference box to optimally fit a predicted object. The regression layer 218 regresses positions of the parts of the object to determine coordinates of the parts.

For each reference box, the classification layer 214 may output two predicted values, one of which is a score for the reference box to be a background, and the other of which is a score for the reference box to be a foreground (an actual object). For example, if a number S of reference boxes are used, the number of output channels of the classification layer 214 is 2S. In some implementations, only different scales may be taken into account, without considering an aspect ratio. In this case, different reference boxes may have different scales.

For each reference box of interest, the regression layer 216 may regress the coordinates of the reference box to output four predicted values. These four predicted values are parameters characterizing offset from a location of the center of the reference box and the size of the reference box, and may represent a predicted box (also referred to as a predicted region). If the IoU between a predicted box and the actual box is greater than a threshold (for example, 0.5), the predicted box is considered to be a positive sample. The IoU represents a ratio of an intersection and a union of two regions, thereby characterizing a similarity between the two regions. It would be appreciated that any other appropriate measure can be used for characterizing the similarity between the two regions.

The regression layer 218 can be used to regress the coordinates of each part. For example, for a predicted box, the regression layer 218 can determine coordinates of the parts associated with the predicted box. For example, the predicted box represents a head of an object, and the parts can represent a forehead, a chin, a left face and a right face, and a left shoulder and a right shoulder.

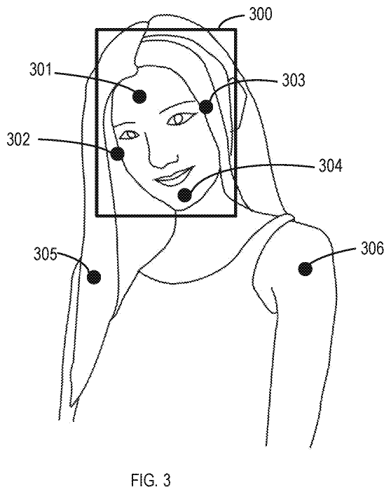

FIG. 3 is a diagram illustrating an object in accordance with an implementation of the subject matter described herein, in which a head region 300 and positions 301-306 of the parts are shown. The head region 300 can represent a predicted box (which is also referred to as a predicted region, candidate region, or candidate box). In addition, the reference box (which is also referred to as the reference region) can has the same scale as the head region 300.

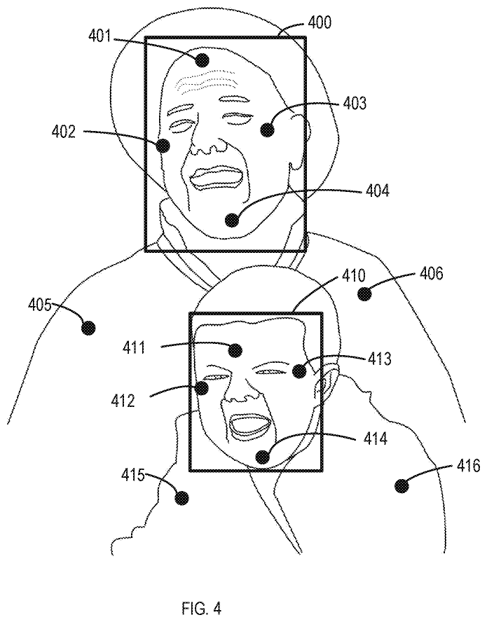

Additionally, FIG. 4 is a diagram illustrating two objects including a plurality of scales in accordance with another implementation of the subject matter as described herein. As shown in FIG. 4, the head region 400 has a first scale, and the head region has a second scale different from the first scale. Also, the parts associated with the head region 400 are respectively located at the locations 401-406, and the parts associated with the head region 410 are respectively located at the locations 411-416. The head region 400 can represent a predicted region. Accordingly, a reference box (also referred to as a reference region) for determining the head region 400 has a first scale, and a reference box for determining the head region 410 has a second scale.

In addition, FIGS. 3 and 4 may also represent annotated data, which include respective annotated regions (also referred to as annotated boxes) and positions of the associated parts. For example, in FIG. 4, the head region 400 can represent an annotated region having a first scale, and the head region 410 represents an annotated region having a second scale. Correspondingly, the positions 401-406 and the positions 411-416 can represent the annotated positions associated with the head regions 400 and 401, respectively.

As shown in FIG. 2, the FCN 206 further provides the second feature map to a deconvolution layer 208 to perform an upsampling operation. As described above, the resolution of the second feature map may be ½ of the resolution of the first feature map, and ⅛ of the resolution of the image 202. In the example, the upsampling ratio may be 2 times, such that the resolution of the fourth feature map output by the deconvolution layer 208 is ¼ of the resolution of the image 202. At a summing node 210, the first feature map output by the FCN 204 may be combined with the fourth feature map to provide the combined feature map to the RPN 226. For example, the first feature map may be element-wise added with the fourth feature map. It would be appreciated that the structure of the neural network 200 is only provided as an example, and one or more network layers or network modules can be added or removed. For example, in some implementations, only the FCN 204 may be provided, and the FCN 206, the deconvolution layer 208 and the like may be removed.

The classification layer 222 is used to determine a probability that each point on the feature map belongs to a certain category. The RPN 226 can address the problem of multiple scale variations using multiple reference boxes each of which may have a respective scale. As described above, a scale or a reference box number can be set to S, the number of the parts is P, and the number of output channels of the classification layer 222 is thus S×(P+1), where the extra channel is used to represent the background. The RPN 226 can output a score of each part for each reference box. The size of the reference box of the RPN 226 can be associated with the size of the reference box of the RPN 224, and for example, can be a half/or other appropriate proportion of the size of the reference box of the RPN 224.

In some implementations, a probability distribution (also referred to as a heatmap) can be used to represent a distribution of probabilities or scores. The heatmap of the part xᵢ [symbol] ² is represented as Hᵢ, and p∈ [symbol] ² is represented as a point on Hᵢ. Thus, Hᵢ can be represented by the following equation (1),

$${H}_{i} ( p ) = exp ( - \frac{{‖ p - {x}_{i} ‖}_{2}^{2}}{{σ}^{2}} ) \qquad ( 1 )$$

where σ represents a spread of a peak value of each part, which corresponds to a respective scale or reference box. That is, different σs are used to characterize different sizes of objects. In this way, each predicted region or predicted box can cover a respective effective region and take the background region into account as little as possible, thereby improving validity of detection on objects having different scales in the image.

During inference, the regression layer 218 can provide the positions of the parts determined by the regression layer 218 to the RPN 226. The RPN 2226 can determine scores of respective positions based on the positions of the parts. A global score output by the classification layer 214 and a local score output by the classification layer 222 are combined to obtain a final score. For example, the two may be combined by the following equation (2).

$$M ( p ) = {M}_{global} ( p ) + {\sum }_{i = 1}^{p} {M}_{part} ( {p}_{i} ) \qquad ( 2 )$$

where M_{global} is a global score output by the classification layer 214, Mₚₐᵣₜ is a local score of the respective scale output by the classification layer 222, p is a point on a final response map, and pᵢ is a coordinate of the i^{th} part. As the global score and the local scores are directed to feature maps having different resolutions, the value of Mₚₐᵣₜ(pᵢ) can be determined by a bilinear interpolation.

In some implementations, only several relatively high scores of the plurality of second scores may be used. For example, in an implementation considering six parts, only three highest scores of the six scores may be considered. In this case, the inaccurate data can be removed to improve prediction accuracy. For example, the left shoulder of a certain object is probably occluded, which has an adverse effect on the prediction accuracy. Accordingly, removing the data can improve the prediction accuracy.

During inference, the neural network 200 can include three outputs, where a first output is a predicted box output by the regression layer 216, the second output is a final score, and the third output is the coordinates of the parts output by the regression layer 218. Therefore, the neural network 200 can produce a large number of candidate regions, associated final scores, and coordinates of the plurality of parts. In this case, some candidate regions may have more overlaps with each other, thus causing redundancy. As described above, FIGS. 3 and 4 illustrate multiple examples of candidate regions. In some implementations, the predicted box having more overlaps can be removed by preforming Non-maximal Suppression (NMS) for the candidate regions (also referred to as predicted boxes). For example, the predicted boxes can be ordered based on the final scores, and the IoU between the predicted box having a lower score and the predicted box having a higher score may be determined. If the IoU is greater than a threshold (for example, 0.5), the predicted box having the lower score may be removed. In this way, the predicted boxes having less overlap may be output. In some implementations, N predicted boxes having relatively higher scores can be further selected to be output from the predicted boxes having less overlap.

In a training process, a loss function of the regression layer 218 can be set as a Euclidean distance loss as shown in the equation (3):

$$ℒ = {\sum }_{p = 1}^{P} ( {( {\hat{x}}_{i}^{p} - ( {x}_{i}^{p} - {x}_{c} ) )}^{2} + {( {\hat{y}}_{i}^{p} - ( {y}_{i}^{p} - {y}_{c} ) )}^{2} ) \qquad ( 3 )$$

where \hat{x}ᵢ^{p} and ŷᵢ^{p} are offset values of the p^{th} part, xᵢ^{p} and yᵢ^{p} are groundtruth coordinates of the p^{th} part, and x_{c} and y_{c} belong to a center of the candidate region (also referred to as the predicted box). By optimizing the loss function, a difference between the offset value between the predicted position and the center of the candidate region and the offset value between the groundtruth position and the center of the candidate region is minimized.

In some implementations, three loss functions of the classification layer 214, and the regression layers 216 and 218 can be combined for the training process. For example, for each positive sample determined in the regression layer 216, the neural network 200, particularly the RPN 224, can be trained by minimizing the combined loss function.

In the training process, the RPN 226 can determine respective scores based on groundtruth positions of a plurality of parts, and enable the scores of the groundtruth positions of the plurality of parts to gradually approximate to labels of the plurality of parts by updating the parameters of the neural network 200. In the training data, only the position of each part may be annotated, and the size of each part is not annotated. However, in the case of multiple scales, each position may correspond to a plurality of reference boxes. Hence, it is required to determine the relation between the position of each part and the reference boxes. For example, a pseudo bounding box may be used for each part. Specifically, the size of each part can be estimated using the size of the head. The head annotation of the i^{th} person can be represented as (xᵢ, yᵢ, wᵢ, hᵢ), where (xᵢ, yᵢ) represents the center of the head, and (wᵢ, hᵢ) represents a width and a height of the head. If the p^{th} part of the person is located in (xᵢ^{p}, yᵢ^{p}), the pseudo bounding box of the part can be represented as (xᵢ^{p}, yᵢ^{p}, αwᵢ, αhᵢ) where α represents a hyperparameter of the part detection, which may for example be set to 0.5.

In the training process, the pseudo bounding box of each part can serve as a groundtruth box of the respective point. In some implementations, each point has a plurality of reference boxes, and, for each reference box, the IoU between the reference box and the groundtruth box may be determined. Any reference box having an IoU with the groundtruth box greater than the threshold (for example, 0.5) may be set to be a positive sample. For example, the label for the positive sample may be set to 1, and the label for the negative sample may be set to 0.

As shown in FIG. 2, the classification layer 222 can perform a multi-class classification, and can output a probability or score of each part for each scale. The parameters of the neural network 200 are updated by enabling the probability of each part to approximate to a respective label (for example, 1 or 0) for each scale. For example, if the IoU between the reference box of the first part having a certain scale and the groundtruth box is greater than the threshold, the reference box can be considered as a positive sample, and the label of the reference box should thus be 1. The parameters of the neural network 200 can be updated by enabling the probability or score of the first part at this scale to approximate to the label (1 in the example). In some implementations, the foregoing training process can be performed only for the positive samples, and the process of selecting the positive samples thus may also be referred to as downsampling.

The object detection in accordance with implementations of the subject matter described herein has a remarkably improved effect, as compared with the face detection and the body detection. In the case of large variations of occlusion and poses, implementations of the subject matter described herein can also produce good detection effects. In addition, since the neural network 200 can be implemented in form of a Full Convolutional Neural Network, it has a high efficiency and can be trained end-to-end, which is apparently more advanced than the traditional two-step algorithm.

Although the architecture and principles of the neural network 200 in accordance with implementations of the subject matter as described herein have been introduced above with reference to FIG. 2, it would be appreciated that various addition, deletion, substitution and modification for the neural network 200 may be made without departing from the scope of the subject matter described herein.

### Example Process

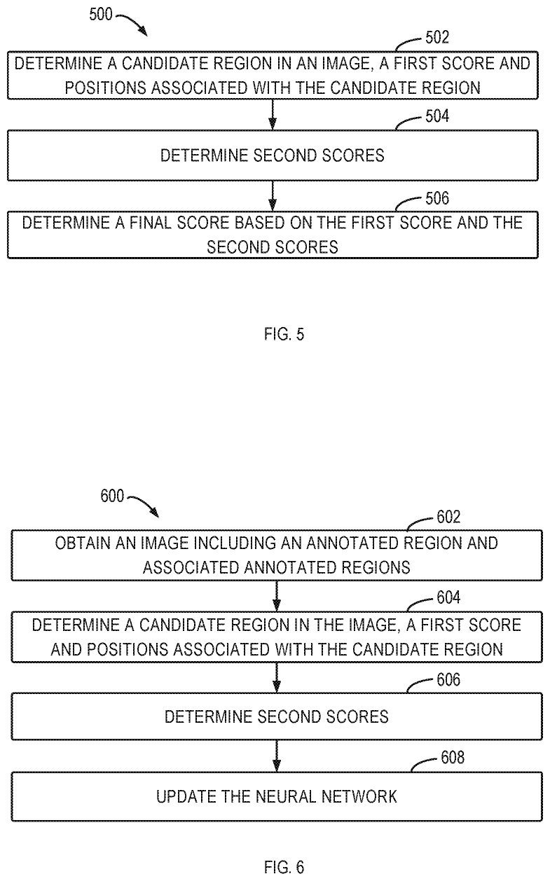

FIG. 5 is a flowchart illustrating a method 500 of object detection in accordance with some implementations of the subject matter described herein. The method 500 may be implemented by the computing device 100, for example at the image processing module 122 in the memory 120 of the computing device 100.

In 502, a candidate region in an image, a first score, and a plurality of positions associated with the candidate region are determined from a feature map of the image. The first score indicates a probability that the candidate region corresponds to a particular portion of the object. For example, these can be determined by the RPN 224 as shown in FIG. 2, where the feature map may represent the second feature map output by the FCN 206 in FIG. 2, the image may be the image 202 as shown in FIG. 2, and the particular portion of the object can be a head of a person. For example, the candidate region can be determined by the regression layer 216, the first score can be determined by the classification layer 214, and the plurality of positions can be determined by the regression layer 218.

In some implementations, the plurality of positions can be determined by determining positional relations between the plurality of positions and the candidate region. For example, the regression layer 218 can determine an offset of the plurality of positions relative to the center of the candidate region. The plurality of positions can be determined finally by combining the offset and the center of the candidate region. For example, if the position of the center of the candidate is (100, 100) and an offset of a position is (50, 50), it can be determined that the position is at (150, 150). In some implementations, since the image includes a plurality of objects having different scales, a plurality of scales different from each other can be provided. In the case, the offset can be combined with respective scales, and for example, if an offset of a position is (5, 5) and the respective scale is 10, the actual offset is (50, 50). The respective positions can be determined based on the actual offset and the center of the candidate region.

In some implementations, a plurality of reference boxes can be provided, and each reference box has a respective scale. Therefore, a candidate region, a first score, and a plurality of positions can be determined based on one of the plurality of reference boxes. For ease of description, the reference box is referred to as a first reference box, and its respective scale is referred to as a first scale. For example, when determining the candidate region, offset values of four parameters (two position coordinates of the center, a width and a height) of the reference box can be determined.

In 504, a plurality of second scores are determined from the feature map. The plurality of second scores indicate probabilities that the plurality of positions correspond to a plurality of parts of the object, respectively. The plurality of parts can be located on the head and shoulders of the object. For example, the plurality of parts can be six parts of the head and shoulders, where four parts are located on the head and two parts are located in the shoulders. For example, four parts of the head may be the forehead, the chin, the left face, and the right face, and the two parts of the shoulders may be the left shoulder and the right shoulder.

In some implementations, a plurality of probability distributions (which is also referred to as heatmaps) can be determined from the feature map. Each of the plurality of probability distributions is associated with a scale and a part. A plurality of second scores can be determined based on the plurality of positions, a first scale, and the plurality of probability distributions. For example, since the plurality of positions are determined based on the first scale, scores of the plurality of positions can be determined from the plurality of probability distributions associated with the first scale. For example, for a scale, each of the plurality of parts is associated with a probability distribution. If a first position corresponds to the left shoulder, the probability or score of the first position is determined from the probability distributions associated with the left shoulder. In this way, probabilities or scores of the plurality of positions can be determined.

In some implementations, a resolution of a feature map can be increased to form a magnified feature map, and the plurality of second scores can be determined based on the magnified feature map. Due to the small size of each part, more local information can be included by increasing the resolution of the feature map, so as to enable the probability or score of each part to be more accurate. In the example of FIG. 2, the magnified second feature is summed element-wise with the first feature map, and the plurality of second scores are determined based on the summed feature map. In this way, better features can be obtained to be supplied to the RPN 226 to better determine the plurality of second scores.

In 506, a final score of the candidate region is determined based on the first score and the plurality of second scores. For example, the first score and the plurality of second scores can be summed to determine the final score of the candidate region. In some implementations, only several high scores from the plurality of second scores may be used. For example, in an implementation of six parts, only three high scores from the six scores may be taken into account. In this case, inaccurate data may be removed to increase prediction accuracy. For example, a left shoulder of a certain object is probably occluded, and thus has an adverse effect on the prediction accuracy. Therefore, removing these data contributes to the improvement for the prediction accuracy.

The above description is provided mainly with reference to a candidate region. It would be appreciated that, in the application or inference process, the method 500 can generate a large number of candidate regions, associated final scores, and a plurality of positions. In this case, some candidate regions may have more overlaps, thus causing redundancy. In some implementations, Non-maximal Suppression (NMS) can be performed for candidate regions (which are also referred to as predicted boxes) to remove predicted boxes having more overlaps. For example, the predicted boxes can be ordered based on the final scores, and the IOUs between predicted boxes having low scores and predicted boxes having high scores can be determined. If the IOUs are greater than a threshold (for example, 0.5), the predicted boxes having low scores can be removed. In this way, a plurality of predicted boxes having less overlap can be output. In some implementations, N predictions boxes can be further selected from these predicted boxes having less overlap to be output.

FIG. 6 is a flowchart illustrating a method 600 for object detection according to some implementations of the subject matter described herein. The method 600 can be implemented by the computing device 100, for example at the image processing module 122 in the memory 120 of the computing device 100.

In 602, an image including an annotated region and a plurality of annotated positions associated with the annotated region is obtained, the annotated region indicating a particular portion of an object, and the plurality of annotated positions corresponding to a plurality of parts of the object. For example, the image may be the image 202 as shown in FIG. 2 or the image as shown in FIG. 3 or 4, the particular part of the object may be a head of a person, and the plurality of parts may be located on the head and shoulders of the person. For example, the plurality of parts may be six parts of the head and shoulders, where four parts are located on the head and two parts are located in the shoulders. For example, the four parts of the head may be the forehead, the chin, the left face, and the right face, and the two parts of the shoulders may be the left shoulder and the right shoulder. In the example, the image 202 can specify a plurality of head regions each of which is defined by a respective annotated box, and the image 202 can also specify coordinates of a plurality of annotated positions corresponding to each head region.

In 604, a candidate region in the image, a first score and a plurality of positions associated with the candidate region are determined from a feature map of the image. The first score indicates a probability that the candidate region corresponds to a particular portion. For example, these can be determined by the RPN 224 as shown in FIG. 2, where the feature map can represent the second feature map output by the FCN 206 in FIG. 2. For example, the candidate region can be determined by the regression layer 216, the first score can be determined by the classification layer 214, and the plurality of positions can be determined by the regression layer 218.

In some implementations, the plurality of positions can be determined by determining positional relations between the plurality of positions and the candidate region. For example, the regression layer 218 can determine offset of the plurality of positions relative to the center of the candidate region. The plurality of positions can be determined finally by combining the offset with the center of the candidate region. For example, if the position of the center of the candidate region is (100, 100) and an offset of one position is (50, 50), it can be determined that the position is at (150, 150). In some implementations, since the image includes therein a plurality of objects having different scales, a plurality of scales different from each other can be provided. In this case, the offset and the respective scale can be combined, and for example, if an offset of a position is (5, 5) and the respective scale is 10, the actual offset amount is (50, 50). The respective position can be determined based on the actual offset amount and the center of the candidate region.

In some implementations, a plurality of reference boxes can be provided, each of which has a respective scale. Therefore, the candidate region, the first score and the plurality of positions can be determined based on one of the plurality of reference boxes. For convenience of description, the reference box is referred to as a first reference box, and its associated scale is referred to as a first scale. For example, when the candidate region is determined, offsets relative to four parameters (the position of the center, the width and the height) of the reference box can be determined.

In some implementations, the above operation can be performed only for positive samples. For example, if it is determined that overlaps (for example, IoU) between the candidate and the annotated regions in the image are greater than a threshold, the operation of determining the plurality of positions will be performed.

In 606, a plurality of second scores are determined from the feature map. The plurality of second scores indicate probabilities that the plurality of annotated positions correspond to the plurality of parts of the object, respectively. Different from the method 500, the annotated positions are used instead of predicted positions.

In some implementations, a plurality of probability distributions (also referred to as heatmaps) can be determined from the feature map. Each of the plurality of probability distributions is associated with a scale and a part. The plurality of second scores can be determined based on the plurality of positions, the first scale, and the plurality of probability distributions. For example, since the plurality of positions can be determined based on the first scale, scores of the plurality of positions can be determined from the plurality of probability distributions associated with the first scale. For example, each of the plurality of parts is associated with a probability distribution, for a given scale. If a first position corresponds to a left shoulder, the probability or score of the first position can be determined from the probability distribution associated with the left shoulder. In this way, probabilities or scores of the plurality of positions can be determined.

In some implementations, a resolution of a feature map can be increased to form a magnified feature map, and a plurality of second scores are determined based on the magnified feature map. Due to the small size of each part, more local information can be encompassed by increasing the resolution of the feature map, to enable the probability or score to be more accurate. In the example of FIG. 2, the magnified second feature map and the first feature map are summed element by element, and the plurality of second scores are determined based on the summed feature map. In this way, better features can be obtained to be supplied to the RPN 226 in order to better determine the plurality of second scores.

In 606, a neural network is updated based on the candidate region, the first score, the plurality of second scores, the plurality of positions, the annotated region and the plurality of annotated positions. In some implementations, a neural network can be updated by minimizing a distance between the plurality of positions and the plurality of annotated positions. This can be implemented based on the Euclidean distance loss as shown in the equation (3).

In some implementations, a plurality of sub-regions associated with the plurality of annotated positions may be determined based on a size of the annotated region. For example, the size of the plurality of sub-regions can be set to be a half of the size of the annotated region, and the plurality of sub-regions are determined based on the plurality of annotated positions. These sub-regions are referred to as pseudo bounding boxes when describing FIG. 2. Since each position can be provided with a plurality of reference boxes, a plurality of labels for the plurality of reference boxes can be determined based on the plurality of sub-regions and the plurality of reference boxes at the plurality of annotated positions. The labels may be 1 or 0, where 1 represents a positive sample and 0 represents a negative sample. Training can be performed only for the positive samples, and thus the process can be referred to as downsampling. For example, the neural network can be updated by minimizing differences between the plurality of second scores and one or more labels of the plurality of labels associated with the first scale.

### Example Implementations

Some example implementations of the subject matter described herein are listed below.

In accordance with some implementations, there is provided a device. The device comprises a processing unit; and a memory coupled to the processing unit and having instructions stored thereon which, when executed by the processing unit, cause the device to perform acts comprising: determining a candidate region in an image, a first score, and a plurality of positions associated with the candidate region from a feature map of the image, the first score indicating a probability that the candidate region corresponds to a particular portion of an object; determining a plurality of second scores from the feature map, the plurality of second scores respectively indicating probabilities that the plurality of positions correspond to a plurality of parts of the object; and determining a final score of the candidate region based on the first score and the plurality of second scores, to identify the particular portion of the object in the image.

In some implementations, determining the plurality of positions comprises: determining positional relations between the plurality of positions and the candidate region; and determining the plurality of positions based on the positional relations.

In some implementations, the candidate region, the first score, and the plurality of positions are determined based on a first scale of a plurality of scales that are different from each other.

In some implementations, determining the plurality of second scores from the feature map comprises: determining a plurality of probability distributions from the feature map, the plurality of probability distributions being associated with the plurality of scales and the plurality of parts, respectively; and determining the plurality of second scores based on the plurality of positions in one of the plurality of probability distributions associated with the first scale.

In some implementations, determining the plurality of second scores from the feature map comprises: increasing a resolution of the feature map to form a magnified feature map; and determining the plurality of second scores based on the magnified feature map.

In some implementations, the particular portion is a head of the object, and wherein the plurality of parts of the object are located on a head and shoulders of the object.

In accordance with some implementations, there is a device. The device comprises a processing unit; and a memory coupled to the processing unit and having instructions stored thereon which, when executed by the processing unit, cause the device to perform acts comprising: obtaining an image including an annotated region and a plurality of annotated positions associated with the annotated region, the annotated region indicating that a particular portion of an object and the plurality of annotated positions corresponding to a plurality of parts of the object; determining, using a neural network, a candidate region in the image, a first score, and a plurality of positions associated with the candidate region from a feature map of the image, the first score indicating a probability that the candidate region corresponds to the particular portion; determining, using the neural network, a plurality of second scores from the feature map, the plurality of second scores indicating probabilities that the plurality of annotated positions correspond to the plurality of parts of the object, respectively; and updating the neural network based on the candidate region, the first score, the plurality of second scores, the plurality of positions, the annotated region, and the plurality of annotated positions.

In some implementations, updating the neural network comprises: updating the neural network by minimizing distances between the plurality of positions and the plurality of annotated positions.

In some implementations, determining the plurality of positions comprises: in response to determining that an overlap between the candidate region and the annotated region is greater than a threshold, determining the plurality of positions.

In some implementations, determining the plurality of positions comprises: determining positional relations between the plurality of positions and the candidate region; and determining the plurality of positions based on the positional relations.

In some implementations, the candidate region, the first score, and the plurality of positions are determined based on a first scale of a plurality of scales that are different from each other.

In some implementations, determining the plurality of second scores from the feature map comprises: determining a plurality of probability distributions from the feature map, the plurality of probability distributions being associated with the plurality of scales and the plurality of parts, respectively; and determining the plurality of second scores based on the plurality of positions in one of the plurality of probability distributions associated with the first scale.

In some implementations, updating the neural network comprises: determining a plurality of sub-regions associated with the plurality of annotated positions based on a size of the annotated region; determining a plurality of labels associated with the first scale and the plurality of annotated positions based on the plurality of sub-regions; and updating the neural network by minimizing a difference between the plurality of second scores and the plurality of labels.

In some implementations, determining the plurality of second scores for the plurality of positions from the feature map comprises: increasing a resolution of the feature map to form a magnified feature map; and determining the plurality of second scores based on the magnified feature map.

In some implementations, the particular region is a head of the object, and wherein the plurality of parts of the object are located on a head and shoulders of the object.

In accordance with some implementations, there is provided with a method. The method comprises: determining a candidate region in an image, a first score, and a plurality of positions associated with the candidate region from a feature map of the image, the first score indicating a probability that the candidate region corresponds to a particular portion of an object; determining a plurality of second scores from the feature map, the plurality of second scores respectively indicating probabilities that the plurality of positions correspond to a plurality of parts of the object; and determining a final score of the candidate region based on the first score and the plurality of second scores, to identify the particular portion of the object in the image.

In some implementations, determining the plurality of positions comprises: determining positional relations between the plurality of positions and the candidate region; and determining the plurality of positions based on the positional relations.

In some implementations, the candidate region, the first score, and the plurality of positions are determined based on a first scale of a plurality of scales that are different from each other.

In some implementations, determining the plurality of second scores from the feature map comprises: determining a plurality of probability distributions from the feature map, the plurality of probability distributions being associated with the plurality of scales and the plurality of parts, respectively; and determining the plurality of second scores based on the plurality of positions in one of the plurality of probability distributions associated with the first scale.

In some implementations, determining the plurality of second scores from the feature map comprises: increasing a resolution of the feature map to form a magnified feature map; and determining the plurality of second scores based on the magnified feature map.

In some implementations, the particular portion is a head of the object, and wherein the plurality of parts of the object are located on a head and shoulders of the object.

In accordance with some implementations, there is a method. The method comprises obtaining an image including an annotated region and a plurality of annotated positions associated with the annotated region, the annotated region indicating that a particular portion of an object and the plurality of annotated positions corresponding to a plurality of parts of the object; determining, using a neural network, a candidate region in the image, a first score, and a plurality of positions associated with the candidate region from a feature map of the image, the first score indicating a probability that the candidate region corresponds to the particular portion; determining, using the neural network, a plurality of second scores from the feature map, the plurality of second scores indicating probabilities that the plurality of annotated positions correspond to the plurality of parts of the object, respectively; and updating the neural network based on the candidate region, the first score, the plurality of second scores, the plurality of positions, the annotated region, and the plurality of annotated positions.

In some implementations, updating the neural network comprises: updating the neural network by minimizing distances between the plurality of positions and the plurality of annotated positions.

In some implementations, determining the plurality of positions comprises: in response to determining that an overlap between the candidate region and the annotated region is greater than a threshold, determining the plurality of positions.

In some implementations, determining the plurality of positions comprises: determining positional relations between the plurality of positions and the candidate region; and determining the plurality of positions based on the positional relations.

In some implementations, the candidate region, the first score, and the plurality of positions are determined based on a first scale of a plurality of scales that are different from each other.

In some implementations, determining the plurality of second scores from the feature map comprises: determining a plurality of probability distributions from the feature map, the plurality of probability distributions being associated with the plurality of scales and the plurality of parts, respectively; and determining the plurality of second scores based on the plurality of positions in one of the plurality of probability distributions associated with the first scale.

In some implementations, updating the neural network comprises: determining a plurality of sub-regions associated with the plurality of annotated positions based on a size of the annotated region; determining a plurality of labels associated with the first scale and the plurality of annotated positions based on the plurality of sub-regions; and updating the neural network by minimizing a difference between the plurality of second scores and the plurality of labels.

In some implementations, determining the plurality of second scores for the plurality of positions from the feature map comprises: increasing a resolution of the feature map to form a magnified feature map; and determining the plurality of second scores based on the magnified feature map.

In some implementations, the particular region is a head of the object, and wherein the plurality of parts of the object are located on a head and shoulders of the object.

In accordance with some implementations, there is provided a computer readable medium having computer executable instructions stored thereon, and the computer executable instructions when executed by a device cause the device to perform the method in the above aspect.

The functionally described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip Systems (SOCs), Complex Programmable Logic Devices (CPLDs), and the like. In addition, the functions as described above can be performed at least in part by a Graphical Processing Unit (GPU).

Program codes for carrying out methods of the subject matter described herein may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program codes may execute entirely on a machine, partly on the machine, as a stand-alone software package, partly on the machine and partly on a remote machine or entirely on the remote machine or server.

In the context of the claimed subject matter, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Conversely, various features that are described in the context of a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. A device, comprising:
a processing unit; and
a memory coupled to the processing unit and having instructions stored thereon which, when executed by the processing unit, cause the device to perform acts comprising:
determining a candidate region in an image, a first score, and a plurality of positions associated with the candidate region from a feature map of the image, the first score indicating a probability that the candidate region corresponds to a particular portion of an object;
determining a plurality of second scores from the feature map, the plurality of second scores respectively indicating probabilities that the plurality of positions correspond to a plurality of parts of the object; and
determining a final score of the candidate region based on the first score and the plurality of second scores, to identify the particular portion of the object in the image.

2. The device of claim 1, wherein determining the plurality of positions comprises:
determining positional relations between the plurality of positions and the candidate region; and
determining the plurality of positions based on the positional relations.

3. The device of claim 1, wherein the candidate region, the first score, and the plurality of positions are determined based on a first scale of a plurality of scales that are different from each other.

4. The device of claim 3, wherein determining the plurality of second scores from the feature map comprises:
determining a plurality of probability distributions from the feature map, the plurality of probability distributions being associated with the plurality of scales and the plurality of parts, respectively; and
determining the plurality of second scores based on the plurality of positions in one of the plurality of probability distributions associated with the first scale.

5. The device of claim 1, wherein determining the plurality of second scores from the feature map comprises:
increasing a resolution of the feature map to form a magnified feature map; and
determining the plurality of second scores based on the magnified feature map.

6. The device of claim 1, wherein the particular portion is a head of the object, and wherein the plurality of parts of the object are located on a head and shoulders of the object.

7. A device, comprising:
a processing unit; and
a memory coupled to the processing unit and having instructions stored thereon which, when executed by the processing unit, cause the device to perform acts comprising:
obtaining an image including an annotated region and a plurality of annotated positions associated with the annotated region, the annotated region indicating that a particular portion of an object and the plurality of annotated positions corresponding to a plurality of parts of the object;
determining, using a neural network, a candidate region in the image, a first score, and a plurality of positions associated with the candidate region from a feature map of the image, the first score indicating a probability that the candidate region corresponds to the particular portion;
determining, using the neural network, a plurality of second scores from the feature map, the plurality of second scores indicating probabilities that the plurality of annotated positions correspond to the plurality of parts of the object, respectively; and
updating the neural network based on the candidate region, the first score, the plurality of second scores, the plurality of positions, the annotated region, and the plurality of annotated positions.

8. The device of claim 7, wherein updating the neural network comprises:
updating the neural network by minimizing distances between the plurality of positions and the plurality of annotated positions.

9. The device of claim 7, wherein determining the plurality of positions comprises:
in response to determining that an overlap between the candidate region and the annotated region is greater than a threshold, determining the plurality of positions.

10. The device of claim 7, wherein determining the plurality of positions comprises:
determining positional relations between the plurality of positions and the candidate region; and
determining the plurality of positions based on the positional relations.

11. The device of claim 7, wherein the candidate region, the first score, and the plurality of positions are determined based on a first scale of a plurality of scales that are different from each other.

12. The device of claim 11, wherein determining the plurality of second scores from the feature map comprises:
determining a plurality of probability distributions from the feature map, the plurality of probability distributions being associated with the plurality of scales and the plurality of parts, respectively; and
determining the plurality of second scores based on the plurality of positions in one of the plurality of probability distributions associated with the first scale.

13. The device of claim 8, wherein updating the neural network comprises:
determining a plurality of sub-regions associated with the plurality of annotated positions based on a size of the annotated region;
determining a plurality of labels associated with the first scale and the plurality of annotated positions based on the plurality of sub-regions; and
updating the neural network by minimizing a difference between the plurality of second scores and the plurality of labels.

14. The device of claim 7, wherein determining the plurality of second scores for the plurality of positions from the feature map comprises:
increasing a resolution of the feature map to form a magnified feature map; and
determining the plurality of second scores based on the magnified feature map.

15. The device of claim 7, wherein the particular region is a head of the object, and wherein the plurality of parts of the object are located on a head and shoulders of the object.
